(19) United States
(12) Patent Application Publication
(10) Pub. No.: US 2005/0229103 A1
(43) Pub. Date: Oct. 13, 2005

(54) Gui and support hardware for maintaining long-term personal access to the world

(76) Inventor: David Michael King, Auckland (NZ)

Correspondence Address: YOUNG & THOMPSON, 745 SOUTH 23RD STREET, 2ND FLOOR, ARLINGTON, VA, 22202, US

(21) Appl. No.: 10/509,386

(22) PCT Filed: Mar. 25, 2003
(86) PCT No.: PCT/NZ03/00051

§ 371 Date: Jun. 6, 2005

(30) Foreign Application Priority Data
Mar. 25, 2002 (NZ) 517971

(51) Int. Cl. G06F 3/00

(52) U.S. Cl. 715/741; 715/865; 715/810; 715/742; 715/743; 715/744; 715/745; 715/746; 715/747

(57) ABSTRACT

An adaptable world interface helps progressively less capable persons maintain contact with friends, relatives, and the outside world, personal entertainment channels, telephone, e-mail, television, household appliances, etc. A hand-held device displays a selected, consistent GUI menu, simplified to match the person's present abilities. A selected ability-matched user interface controls a programmed set-top box feeding appropriate output devices. People may start using the invention while young and able so that, before possible disability begins and entry into hospital care commences, the person is already used to managing the world interface. Remote medical consultations are provided for.

### FIELD

In general, this invention relates to provision of communications channels between the world and an individual of advancing age, and in particular this invention relates to provision of a consistent and intuitive interface for managing set-top boxes and other appliances so that access to the world can be maintained during one's lifetime. One principle of this invention is to give people the opportunity of becoming accustomed to the GUI in itself and as a way of controlling appliances, A-V channels and communications prior to really needing it.

### BACKGROUND

This invention is related to the difficulties people have in using technology to make contact with their environment—such as using remote controls to operate video tape recorders. Industrial designers create products often incompatible with some people, such as left-handed, disabled, or geriatric groups. Consider the current trends to smallness in cellular telephone design. Almost all entertainment equipment (such as CD players) is provided in solid black boxes with poorly visible markings and instructions (often embossed in black) all hard to see if one's eyesight is less than perfect or if viewed in poorly lit environments.

Development began with considerations of the difficulties faced by the often solitary elderly person, particularly when seeking contact and entertainment despite disabilities including immobility—and these difficulties are by no means limited to the elderly. Retired, disabled, and geriatric individuals need to be properly involved with life by being entertained, mentally stimulated, and by communicating with others, especially when the ability, or the desire to try to cope with complexities of technical equipment such as computers and operating system quirks is diminished. These devices are not user-friendly to a “late starter”. The elderly are often lonely and isolated from their community of family and friends, and made insecure by a lack of ability to keep up with modern products. There is a need for a trustworthy link to the outside world and those support services to which access is increasingly being assumed. Anything that makes use of modem developments to enhance life is beneficial for the sake of keeping people in their own homes for as long as possible. In particular, people in care, in retirement homes or hospitals, are often separated from friends and relatives yet would enjoy frequent contact if it was possible. Entertaining a number of residents by placing them in front of a television set showing infomercials all afternoon is not ideal. Failure to keep the brain active leads to loss of powers.

Nowadays the elderly remain in their own homes for longer periods, because of financial constraints, personal preferences, and government policy. The increasing proportion of elderly people, on its own, results in a large change in society. (In Japan, half the population will be 50 and over within about 2 years). About 1 in 10 New Zealanders have a sensory disability that cannot be corrected by special equipment. Elderly people living alone are isolated, fearful in their insecurity, and usually separated both from their family and from essential support services. This is made worse if the person is even partly immobilised. Meanwhile, many have never used a computer yet e-mail is a widely used highly convenient form of correspondence for those who do. Few experienced computer users can appreciate the degree of difficulty experienced by a naive user with a personal computer having the usual keyboard, mouse, and an operating system that tries to be too clever rather than simply helpful. Intra-house networks exist for appliance control some of which use the mains electricity wiring as the network. Many older people use the fax or a combination telephone/fax/answering machine) as a fast, convenient replacement for the postal service in communication. Computer skills within the older age group are growing but competence is probably well under 5% in New Zealand. Although there are many movements such as “U3A” that foster learning and social activity amongst the elderly, many people in need of the resulting stimulation are not physically able to join in. There is a need to return communications and entertainment systems to an “easy-to-reach” status, whether they are used for necessities such as reaching a doctor, for entertainment such as radio or TV programmes, or for simple telephone calls (hard enough given poor eyesight and small print in the telephone directory). Benefits may lie in use of remote, interactive practitioner-patient encounters with the assistance of “webcams” or similar to check on patients' health, state of mind, and their medications over a telephone line without making actual visits at least in the first instance. The inventor calls his concept “EZILINK”.

### PRIOR ART REVIEW

Many advances have been made in fields such as the set-top box (and analogues) for selecting from incoming entertainment channels for display on a television set. Technical developments within electronic devices have reached a high degree of development but aspects of the user interface that matter to ordinary people and especially to older people have not, as yet, received much attention.

Starting from standard line-by-line computer directory or menu displays, Callahan J et al, Proc SIGCHI conference, Washington D.C. (1988) EMPIRICAL COMPARISON OF PIE VS LINEAR MENUS and Shneiderman B et al IRLIST Digest (3 Aug. 1992) NEW INFORMATION VISUALIZATION TOOLS provide examples of ways to represent files graphically; the first by use of pie diagrams and the second using rectangles of varying sizes. Perttunen, in U.S. Pat. No. 6,359,635, (a kind of pie-shaped-representation) and Halachmi et al U.S. Pat. No. 6,104,400 (a star-shaped representation) both describe 2-D pictorial interfaces, but neither stress the aspects considered important for the present application. Their interests lay more in representing very large structures rather than consistent layouts.

Scott in U.S. Pat. No. 6,083,270 links a variety of customised personal interfaces across a standard “bridge” into an ordinary PC so that persons disabled in various ways can use the computer. Ferrier et al in U.S. Pat. No. 5,260,869 describes a weight/position sensor to cause a computer to give useful and developmentally encouraging feedback for a baby with brain damage. Fries in 6,317,885 describes a set-top box (STB)-as a co-ordinator of a household information system though this invention relates to bringing specified-types of information together. Bellamy, U.S. Pat. No. 6,209,025, Bendinelli et al U.S. Pat. No. 6,061,719, and Strauss et al U.S. Pat. No. 5,790,173, as well as many manufacturers' information sheets relate to STB design. Medical aspects of personal two-way communications links between a medical service provider and an individual are for example described in Flego et al U.S. Pat. No. 5,903,211 and many publications in the medical arena such as “Workshop on Home Care Technologies for the 21st Century” published on the Web by Jack Winters, Biomedical Engineering, Catholic University of America, at www.eng.mdu/wintersj/HCTworkshop/ . . . and read on 2 Mar. 2003.

### PROBLEM TO BE SOLVED

We see the problem to be solved as “the provision of a user-compatible world interface to help progressively less capable persons maintain contact with friends and relatives and the outside world, through (for example) personal entertainment channels, telephone, e-mail, television, world-wide web, household appliances, thereby avoiding loneliness and insecurity, and making use of community health and other social and commercial services, even if substantially disabled”.

### OBJECT

It is an object of this invention to provide communications and entertainment equipment in an integrated, user-compatible form, at least in a form suitable for the elderly, or at least to provide the public with a useful choice.

### STATEMENT OF INVENTION

In a first broad aspect this invention provides apparatus of the general type known as a “set top box” capable in use of providing at least one communication channel between a display device presented to an individual and a source of information, wherein control of the set top box is provided by means of a customised controlling device (including both apparatus and a set of control instructions), adapted in order to match the ability of the individual to operate the controlling device and gain access to the at least one communication channel especially if the individual has a degree of disability.

Preferably the STB is capable of selecting at least one channel of information and entertainment for personal access by the individual.

In an alternative aspect this invention provides an adaptable world interface including a graphical user interface (GUI), support hardware, and software for maintaining personal access to services, information and entertainment from audio-visual channels, communications channels, and the like over a long period, even if the individual becomes disabled wherein the means includes an adaptable GUI menu, capable of displaying (a) a variety of presented levels of complexity, any one level of which may be selected from time to time according to the individual's level, and (b) a consistent spatial layout regardless of the currently presented level of complexity, a selected GUI host device capable of presenting the menu to the user, at least one adaptable means for accepting at least one actuating command from the user, at least one operable device capable of being controlled by the GUI host device in response to an actuating command, and an output device capable of displaying the audio-visual channels, communications channels, and the like so that an individual of any level of capability is able to comprehend a compatible GUI menu and operate the system control interface, and so that the individual has the opportunity of becoming accustomed to the invention over a period prior to a possible onset of disability.

Preferably the adaptable world interface is provided with means for communicating with at least one appliance connected to the operable device.

Preferably the individual's responses are received by ability-scalable means capable of being altered according to the level of capability of the individual, so that an individual of any level of ability is able to control the system to some extent at least.

Preferably the menu is designed so that any view of a portion of the menu includes information locating that view within the whole, the menu is laid out in a spatially consistent manner in which a plurality of items are displayed in consistent positions (if present), regardless of level of complexity, and the menu is viewed through a virtual window, the size of which may be altered according to the level of capability of the individual so that an individual of lower level is not confused yet a higher level individual is not frustrated.

Optionally the menu is presented to the individual in audible form.

Optionally one or more actuating commands are returned by the individual to the apparatus in audible form.

In a second broad aspect the invention provides means for remotely linking one or more persons with a health services provider, wherein the means includes a GUI, together with hardware for personal physical health status data collection, in order to facilitate health consultations by telephone, so that community health services may be made more proactive.

In a third broad aspect the invention provides means for linking one or more persons in a dwelling with an audiovisual channel provider, whereint least one channel of audiovisual material is brought to the operable device as claimed in claim 1, and the at least one channel carries material relevant to the persons in the dwelling, so that the persons are supplied with relevant audiovisual material.

In a related aspect the invention provides means for supplying one or more persons with audiovisual material, wherein at least some of the material is collated by electronic programme gathering means so that the individual can enjoy the material without having to pursue the material on a programme-by-programme basis.

In a related aspect, the selected controlling device is provided with a set of operational controlling instructions compatible with those used within the set top box, so that the set top box can be controlling by the commands issued.

In a further related aspect, at least some of the customisation of a controlling device is optionally provided for within the operational controlling instructions, so that optimisation of the match between the user and the controller can be improved.

In a still further aspect, the operational controlling instructions are provided within a memory module built into the controlling device.

In a yet still further aspect, the operational controlling instructions are provided within a memory module supplied along with the controlling device, for connection with the set top box.

Preferably the conceptual difficulty of the control information presented is matched to the capability of the individual.

Preferably the format of control information presented is matched to the capability of the individual.

Optionally the selected controlling device or the set top box in combination is capable of noting the pattern of use over time by the individual and of carrying out an action in the event of a change of the pattern of use.

In a fourth broad aspect, the selected controlling device or the set top box in combination may be loaded with data relating to the individual which is not likely to change, such as identification numbers, names of relatives, passwords to often visited sites (such as family web sites), so that this individual data is not lost when the selected controlling device is exchanged.

In a fifth broad aspect, the set top box may be loaded with a sequence of instructions comprising a programme of entertainment by an individual.

### PREFERRED EMBODIMENT

The description of the invention to be provided herein is given purely by way of example and is not to be taken in any way as limiting the scope or extent of the invention.

### DRAWINGS

FIG. 1: is a diagram showing the overall layout of the invention, including a range of control units each with a range of software.

FIG. 2: is a diagram showing an example control device so that a disabled person can control a STB using a typical screen. (This is one of many specific possibilities).

FIG. 3: is a sectional diagram showing a compact version of the invention (with its protective case removed).

FIG. 4: is one implementation of a menu layout.

FIG. 5: is a minimal implementation of FIG. 4.

FIG. 6: is a block diagram of a GUI host.

FIG. 7: shows a microprocessor-based device like a “Palm Pilot” (R) as a self-contained processor for displaying the menu selections and accepting commands, here using part of the menu layout of FIG. 4.

FIG. 8: uses a cellular telephone with modifications to act as the processor for rendering the menu and accepting commands again using the menu layout of FIG. 4.

The technical inventive step is believed to lie particularly in providing a personal graphical user interface or GUI which endeavours to provide an intuitive interface, an “adaptable world interface” so that a person can control a range of appliances, reach a number of entertainment channels, and reach a number of communication channels with ease and confidence. An important aspect is considered to be that the GUI is scalable in order to match the display device on which it is presented, particularly in order to meet the present capabilities of the person using it, yet remains consistent with its former appearance so that even a user of severely reduced capability who has previously used the GUI is still familiar with the GUI layout and can retain a useful (personally satisfying) degree of command over the available devices. Our invention is intended to be suitable for and acceptable to persons of any age—even teenagers—so that familiarity with the control means may be acquired when young. Although sensor motor capability is inevitably lost with age to some extent, persons will retain their learned familiarity with the environment and be better able to use this unified system. The invention is partly based on the following:
a) that a person's mental powers to cope with the procedures for controlling of complex devices tends to diminish with age,
b) that a person's desire to understand, accept and overcome the intricacies of much modern software including operating systems tends to diminish with age (if that desire was ever there),
c) the value of being able to use a personal GUI of the type considered, especially if a person is elderly, infirm or disabled yet wants or needs to be entertained, conversed with, or be involved in activities in order to keep the mind active, and
d) that their physical powers to competently operate a pointing device such as a computer mouse will tend in time and particularly if neural defects such as strokes or neuromuscular disease exist to become limited to simple devices like the squeeze bulb of FIG. 2.
   Overall Hardware

In an old person's room such as one in an institution where the person is under care and is relatively incapacitated, the GUI which is the basis of the invention would physically be included within:
a) A device (a) for accepting user commands to control appliances and entertainment and communications channels, capable of displaying the GUI and accepting user input, and communicating with . . .
b) A device (b) for receiving device (a) signals whenever the user has commanded some operation, in some cases causing the command to take effect and in other cases passing the command to a network of controls,
c) Optionally, a network linking one or more controllable appliances together by wired or wireless means, permitting actuation of specific devices and optionally receiving inputs from at least some of them,
d) Some controllable devices or appliances such as room lighting (several lights possibly), room heating, door controls, window controls, air conditioning or fans, electrically operated beds, radio, recorded music and television channels, volume, and mutes,
e) and means for calling for attention from the nursing staff

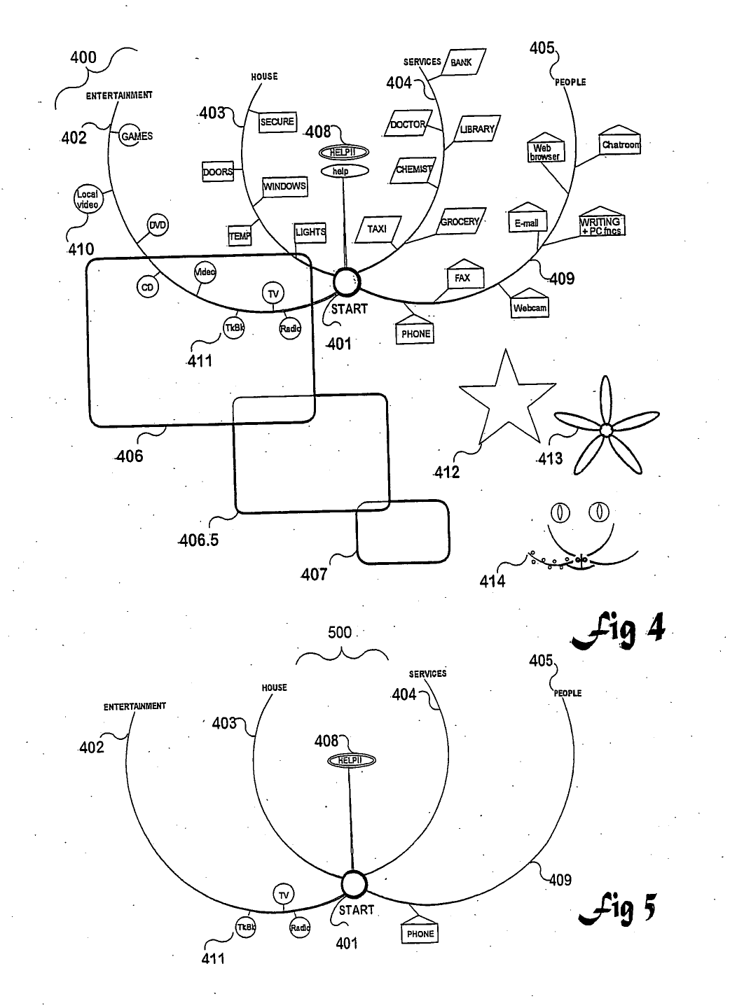

In a house, many more devices or appliances beyond those described above would exist, such as more rooms with controllable lighting, appliances for heating, air conditioning, cooking and laundry, and one or more personal computers. There would be more channels for entertainment, information and communications devices such as radio, Internet, CD, DVD, and telephone/fax/e-mail/word processing, all of which may be engaged with much more intensity. No nurse-call intercom is needed, but means to raise an alarm for use in any emergency is useful. Hence the GUI (FIG. 4) would include more icons.

A telephone function is likely to be always needed. It may be a totally separate device or may be built into device (a) or into device (b). A fax (facsimile) function may be a separate device or handled within software within devices (a) or (b). For those familiar with features of computers, a computer with Internet, e-mail and word processing functions may be used, although many would prefer that it was somewhat simplified in comparison with the difficulty and impediments to use that are imposed by current operating systems. A keyboard input is the most convenient way to enter text. The invention may either actually provide, or appear to provide, a simple version of a computer operating system acting in accordance with the problem to be solved (see above).

### EXAMPLE 1A

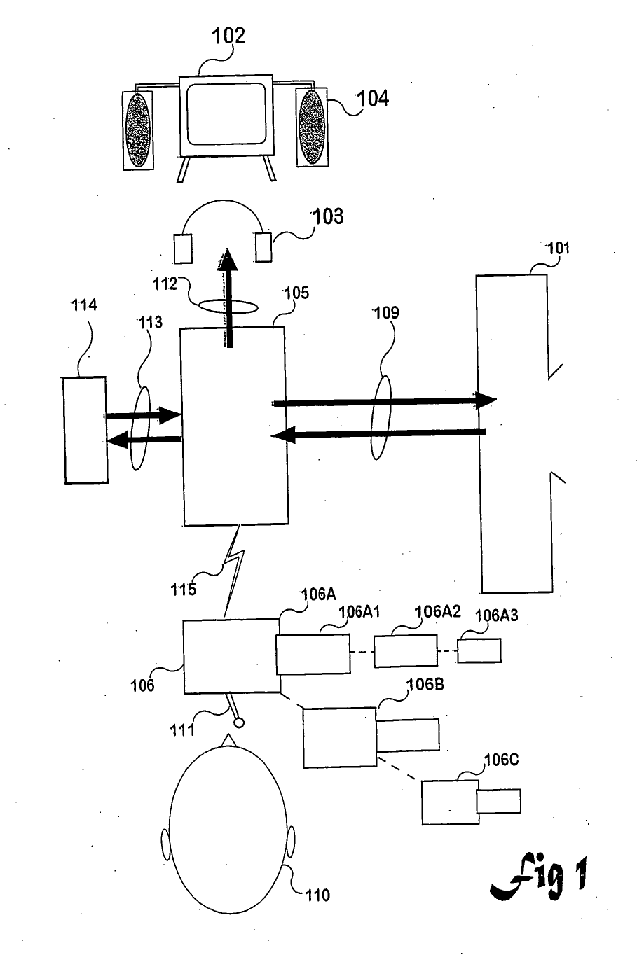

To illustrate the D adaptable world interface “invention in one practical form, FIG. 1 depicts
(a) A STB 105. As is usual in the art, the STB is connected (fines 109) to a range of communications channels 101 (see Table 1, below).
(b) Appliances for entertainment of the user 110 include for example a television set 102 or similar visual display device, and aural devices such as earphones 103 or speakers 104.
(c) The GUI is held in a GUI host or in a selected one of a consistent range of specific interface hardware sets (106A1, A2, and A3), being a range of comparable devices having human input devices (like joystick 111) selected on a case-by-case basis and with the expression of the GUI adjusted to match the present capabilities of the user 110.
(d) Optionally, data network 113 carries commands to a set of household appliances 114 (see table 2, below) and may receive status reports from them (such as lockable door status) for showing to the user.

This invention is at least partly concerned with means to make control of the incoming entertainment as easy as possible. Necessary displays and instructions may be superimposed on to the television set display, and some may be sounds. It is likely that 101-105 will comprise existing apparatus, though including some novel software. Even the infra-red link 115 is a conventional part of a STB. A further part of the invention is shown here as 106A, 106B and 106C representing an arbitrary range of appropriate physical interfaces (one of which is selected from the range in order to match a given state of competence or personal skills; here described in seven levels later in this section). Any physical interface will have corresponding control and display software used within (for example) interface 106A. The range of choices of interface can be large, and can be tailored to use by a specific person by selection from the range of the software optionally with suitable modification. Preferably all interfaces and software share, as far as possible, a common “look and feel” so that a user, when shifting to another interface, finds all aspects remain familiar. At least interfaces close to each other in the range are similar, even if differences unavoidably exist from one end of the range to the other. See FIG. 4 and related text.

The specific interface hardware 106A . . . A1, A2, A3 and 106B, 106C may be standard items, such as (but not limited to) mouse or similar pointing devices, keyboard, microphone and speech-controlled software, or customised disabled-compatible devices such as pressure-operated bulbs leading to transducers or switches, or head-operated devices, and the like (as are known in the art). Consistency of presentation is referred to in relation to FIGS. 4 and 5.

One example of a disabled-type interface in conjunction with a STB is option 200 shown in FIG. 2. The rubber bulb 201 also includes a nurse call button 202. A pressure transducer within is connected by wire 203 (or infra-red link) to the STB 105. The television-type display 102 is shown with a “manometer metaphor” 204—currently reflecting squeeze pressure by rising to 205 (or beyond) This interface may for example be configured so that after a short period of squeezing the bulb at a more or less constant pressure, the choice such as 207 at the right of the guide line 206 is activated, and is optionally acknowledged in an “are you sure?” mode. Where a choice leads to further choices, the row of dots 208 as favoured for indicating further choices in computer menus may be used. No squeeze at all deactivates the menu screen and the system reverts to showing television, for example. The reader will appreciate that software gives a designer a considerable amount of freedom to create a complete interface using nothing more complex than a squeezable bulb. This GUI is admittedly unlike the preferred GUI of the invention (FIG. 4) but the interface, comprising an analogue and a switch inputs, could be coupled so as to cycle around available icons by pressing, then squeezing to select a particular function.

In FIG. 1, 101 represents media that may be used as “channels to or from the world”.

TABLE 1
non-limiting list of examples of media of external origin.

Any prepared audio/visual material to be distributed to people on demand
or at a fixed time, such as library-sourced talking books, pre-loaded onto
a hard disk, or eBooks.
Communication with others on the same intranet.
Locally made videos, music productions, game shows, church services etc
broadcast around a retirement village. Community broadcasts.
Automatic emergency calls from medical alert devices or security alarms
Faxes
Devices for the disabled (TTY for deaf people over the phone etc)
Games; one-player (e.g. war and fantasy games), interactive card games
500 and bridge, “Scrabble (TM)”, chess, Bingo, etc.
Conference call type conversations; broad-band or limited data rate,
optionally using an Internet carrier. Two-way, optionally with video,
telephone links for communication between individuals and relatives.
Families may include movies etc on their family web sites.
Modems to access the Web (including access to services such as news, e-
commerce, grocery shopping, library, banking, doctor, nurse, chemist,
taxi, cleaning services, weather).
Further web sites adapted for use by the elderly. See <www.uib.no/isf/
guide/geri.htm> for a list of services. Web sites with built-in filters to
target relevant sites, or to display outputs in large formats (that suit the TV
as a display device or suit poor eyesight).
Includes one-to-one interactive communications such as for health consul-
tations over the Web A digital camera device (webcam style) may be
useful.
Special pages may cater for on-line shopping, banking, and medical
services including pharmacists, nurses, doctors, and emergency services.
Interactive TV and radio especially Grey Power, U3A, and other groups of
the elderly, including conversations and games.
Receive TV, local or satellite. Electronic programme guides (EPGs). An
(optional) hard disk within the STB can store digital television pro-
grammes so replay may be delayed.
Receive AM or FM radio, community broadcasts, local news, etc.
Foreign-language radio (such as via Internet) for persons not proficient in
the host country language. Elderly or disabled people are particularly dis-
advantaged if they are foreign-born and do not speak the language of the
country where they live.

As is the case for present STBs, the user can control the STB by means of a wireless link 115 and cause it to transfer a selected channel from the outside world to the TV set or other display. The GUI host (see later) is programmed to generate suitable command signals in response to GUI-based selection of an icon and then selection of control operations of a selected appliance.

The video and sound output of the STB 105 would most probably be passed through a standard television receiver 102 and/or through an audio amplifier to speakers 104 or headphones 103. Concerning the user in relation to the special aspects of the invention, the invention is capable of being used by a perfectly healthy individual at home, then as he or she ages or perhaps becomes disabled, the control interface is able to be adapted so that the individual can continue to enjoy a familiar environment—although the means of reaching it may have to be altered. Even if the user is moved into an institution, the invention can be brought too, thus retaining the user's links with the world through a familiar medium.

Table 2 lists some examples of locally controllable channels and appliances.

TABLE 2
non-limiting list of examples of locally made channels and appliances.

air circulation (windows, fans)
CD, mini-disk, DVD players, cassette players, vinyl and shellac (78 rpm)
records, etc.
doors, windows, curtains, electric beds, electric wheelchair chargers
game machines (eg “X-box” (a Microsoft trade mark) and equivalents)
hard disk in STB holding pre-recorded material; EPG-based collection.
heating/cooling/air conditioning
laundry, cooking, and other appliances.
room and outside lighting
security status, locks

The GUI Itself

We consider that desirable features of a graphical user interface or selection interface include some or all of:
1. Compatibility or “sufficient simplicity” with persons having a wide variety of competenicies. (See Levels 1-7 elsewhere in this document). An example way to grade the difficulty of display as per the portion of FIG. 1 labelled 106A, 106B and 106C is to provide windows of varying sizes (406, 407 in FIG. 4) for viewing the layout The smaller view (of course expanded to fill the display screen) offers less choices from the entire GUI. This is less confusing, easier to manipulate, and easier to see and understand.
2. Being an analogue of a real situation, and remaining consistent in its spatial layout regardless of degree of adaptation to competency so that the positioning remains unaltered and so that any displayed part of the menu includes clues as to overall location. The user knows where she/he is by looking at any window. The well-developed spatial orientation-based capacity of a human to re-locate icons or position on a menu mainly by X-Y position is used with this approach to GUIs.
3. Feedback to the user whenever an instruction is given.
4. Ease of recovery from any situation, especially undesired actions made by mistake.
5. Clear, simple presentation of choices.
6. Provision for easy traversing of a menu back and forth.
7. Ease of use, wherein human needs are given priority over technical limitations (for example so that no use of 7-segment displays to emulate letters is made). Text information, if required, is made large enough to be read easily. A “text zoom” software routine or graphics card “magnifier” may be useful for displays that do not naturally use sufficiently large characters. That type of feature usually makes interface usage more complicated. In addition, the interface may provide control over personal or household devices.
8. Avoid giving the user the impression that “the machine is taking over”. A well-meaning puppy or kitten” metaphor for example could be employed by displaying images on the screen as a kind of prompt and to help overcome user resistance.
9. A built-in learning ability, such as an ability of the invention to remember what the individual did the last time the interface was used (or used in this particular way) and suggest that same action as a preferred choice. However this may run against the principle that the machine shall not take over and surprise the user by being inconsistent
10. Nevertheless, the “learning” option can lead to a monitoring function. For example if the person stops using the invention in their usual way, the cause may be an illness such as a transient ischemic attack (TIA or mini-stroke). If the person is under the supervision of an agency and lives alone, a change in behaviour could be signalled to the agency so that someone calls and checks on the person in case an apparent change has a medical cause.

Accordingly we have designed a graphical user interface (GUI) having a primarily visual layout (see FIG. 4) that illustrates the desirable features in principle. An example stylised design 400 is based on the metaphor of an espaliered fruit tree with five branches—something that will be familiar to most people yet does not have connotations that preclude some classes of people from identifying with the metaphor. It must be emphasised that the GUI depicted is described by way of example and is not restrictive of the invention. Other possible metaphors include—a five-pointed star 412, a flower seen face-on with say 4-5 petals each of a different colour 413, or a schematic cat's face with just a few whiskers 414. Each branch of the example GUI may be distinctively coloured, shaped, oriented, and tapered so that current user position within the entire menu (which branch and where along the branch) is reasonably clear at any time from the display 501. (Colour may not be the best of identifiers if monochrome displays are used or colour-blind people use the GUI and hardware). Each branch is festooned with a number of active areas which may appear as representative icons optionally with written names in English or another language, or “blobs” represented as a symbol, colour, shape, or simply be known by position. Note that the total number of active areas requiring icons is not very large (5 to 50) whereas the cited prior art tries to cope with large numbers but was not concerned with consistency. According to this invention, the user would move about the limited number of branches of the tree using a pointing device, and would always find the same thing (represented by an icon) at the same place. Each branch has a characteristic slope so that even with only a small window open into to the GUI, a user can see which branch—and which part of any branch—he or she is currently traversing.

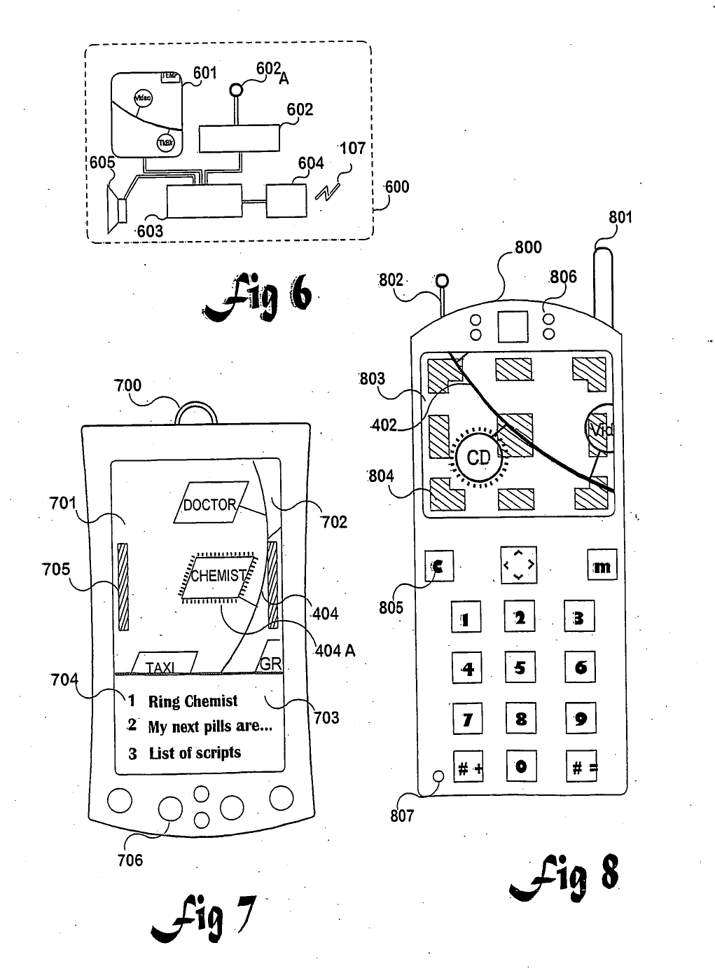

On initial selection by movement of a control device; mouse, touch screen, hand movement or the like, the selected icon changes appearance and may cause emission of a characteristic sound. (See FIG. 7) If an icon is already active, it may be shown initially brighter, or, if it needs attention (an incoming telephone call or a smoke alarm, for example), it may be flashing. Most icons will have the property of expanding into, or setting out, a usually device-specific layout (or range of layouts, dependent in part on the user's level of competence) that temporarily occupy part or all of the display screen and allow any relevant parameter to be changed. For example the expanded TV icon allows for on/off, programme selection, volume, mute, and optionally other controls. Should all expanded icons have the same layout? Although this would add to consistency it is likely to add to confusion though lack of distinctiveness and in any case, specific appliances have mostly unique functions beyond basic on/off commands.

Branch 1 (402) carries entertainment functions (inside circles). The most frequently required icons are preferably closest to the root 401. Should all GUIs have exactly the same layout, or should each one be customised? Because we expect a person to make use of the same GUI through life, it is likely that the same icon (if active) will always be placed at the same site in any GUI. If a device is absent, the icon disappears. Should newly invented devices arrive, they should be placed close to similar devices. For ease of use, devices such as radio and TV that are likely to remain in use until the end of one's life should be nearest the root or starting point of the GUI. Accordingly, FIG. 5 shows a simplified GUI with only a few icons.

Branch 2 (403) empowers the user to control functions around the house. Many of these may be active at any time. Depending on the user's needs, motor-controlled doors, windows, and blinds may be provided. Remotely controllable lighting may be provided and optionally combined with intelligent lighting. A “Secure” function is intended to show the present status of a security controller and whether doors and windows are locked or not.

Branch 3 (404) reaches external services, usually by means of the telephone or the Web (grocery/other shopping, chemist, library and the bank). For example a taxi may be ordered simply by a pre-recorded message sent by telephone. The DOCTOR icon may, for some users, bring up an interactive procedure wherein the patient's pill consumption is checked, the patient may be viewed through a web camera by a nurse or doctor in a medical centre, and devices such as thermometers, blood sugar meters, or ECGs which the user can apply to himself or herself may electronically send reports to the medical centre. There is a world-wide trend for individual and community health to be better (and more cheaply) supported by means of health care, proactive monitoring and examinations accessed from the home rather than “fire-brigade” responses likely to involve hospital time. Institutional health care will continue to migrate from the institution. Accordingly, this aspect of the invention is relatively important. (Interactive procedures of this type are well known from a host of publications, but to date have not been taken up on a wide scale).

Branch 4 (405) labelled “People” carries a variety of communications functions, starting with a phone or phone/fax combination. The “Webcam” option initiates or answers a video/audio call of particular use for communicating with relations. Icons further along this branch (e-mail, writing documents, web browser, and chatroom) probably require typing skills as when using a computer, although speech-based computing may be more suitable for some users and specific developments may open other options to a user with a damaged 120 neuromuscular capability. Some of the GUI hosts under consideration (such as a PDA) provide sufficient support for document generation and viewing to not need any additional computer support, although a printer may be useful.

An optional vertical branch reaches an appropriate “HELP” icon (408) directly, for calling the nurse, or the police, or other emergency services. Graded levels of nurse call are useful in a rest home where falling over is amore urgent problem than missing a cup of tea.

Installation.

A customisation process would include assessing each customer against a range of descriptions, selecting suitable hardware (in relation to vision, motor control positive mental attitude and the like), and optimising the menu display in order to discard icons for absent objects. A suitable GUI host and suitable user controls (mouse, joystick speech or the like) are selected. Some people may not be able to relate to use of a touch screen LCD display as the route for communications, and for those an on-television display (as per FIGS. 1 (with 4) or FIG. 2 may be preferred. A sound analogue of the GUI of FIG. 4 may be dictated by poor vision or poor motor control of either hand. An installer may install a comprehensive programme in a GUI host and, using a checklist, then adjust the programme to suit, for example by setting or clearing bits in one or more registers in stored software (programme variables), a silicon chip, or in a physical switch array (DIP switches or similar). From time to time the programme may be adjusted towards a simpler or a more complex mode according to the user's current aptitude.

1. People of low capability, or those with a low-resolution display device, can work within a small viewing window 407 that shows little more than the branch adjacent to the single icon in the view. At least that indicates the direction to next and previous icons. People with better abilities (or better technology) may use a larger window 406 which might encompass the entire diagram.

2. The design is a graphic implemented in software for display on a suitable screen and is responsive to site-specific actions, such as touching a touch screen. Modification after initial installation is possible.

3. Control of the display—as in moving about the design, or for activating functions made available, may be done by software within a GUI host, STB, PC box or the like, capable at least of displaying the GUI or parts thereof and of accepting user responses. In addition, alerts to the user may be sent such as if the telephone or doorbell is ringing.

4. Very limited abilities may invoke a different programme—such as sequencing through just a few favourite icons.

5. The design and complexity of the individual control panel corresponding to an icon will depend on the specific device represented by the icon. For example, “TAXI” may reveal commands such as “Call a taxi to arrive in 30 minutes”, “Dial the number”, etc while TV uses commands such as on/off/mute/louder/quieter/channel 1/channel 6/AV/etc.

Host for GUI

The device that holds the GUI would include a digital processor and communicate with a command implementor, for example a STB for directly managing some audiovisual entertainment channels, communication channels, and optionally access a local network to which any house management devices capable of digital control are linked. Is there an existing device sufficiently close to the ideal, so that mass production lowers costs? Families of control/interface devices capable of managing the graphical user interface, designed to be carried upon the person such as around the neck on a cord or in a pocket exist, and include:

GUI Host is a Touch-Screen LCD-Based Universal Remote Control Unit.

(a) display means: a large LCD panel that has the desired spatial consistency over time, if the screen is printed at the time of manufacture in a specific layout. Some versions employ selective button lighting once an appliance to be controlled has been selected. The physical appearance generally resembles the device in FIG. 7.
(b) user-controllable inputs: comprising a touch-sensitive screen laid over the LCD panel. This is an intuitive control.
(c) internal processing means: comprising means to detect a touch and convert it into a code to be transmitted according to the mode (target device) currently selected,
(d) wire-free communications: usually infra-red LED.
(e) a graphical user interface: embodied in the screen layout at the time of manufacture.

This type of device has been designed for the purpose of human control of a number of appliances, and is packaged and powered accordingly. Given a suitable volume of production, the screen layout and corresponding transmitted codes can be customised to provide the “tree” structure preferred for the GUI of this invention. A real benefit is that there is no “boot-up” procedure as commonly seen on computers. Limitations are that the device is “transmit-only”, could not easily generate messages, and was originally intended to communicate directly using a limited range of commands to a selected one of many appliances such as DVD, satellite TV, television, amplifier etc.

GUI host is a personal data assistant (e.g. Palm, H-P/Compaq, Sharp, Sony, Acer, Toshiba, Dell and other manufacturers). The unit 700 in FIG. 7 is based on a Palm m515.
(a) display means: a large legible LCD panel 701 that comprises a fully program-controlled monochrome or colour pixel array, preferably with back-lighting
(b) user-controllable inputs: a touch-sensitive screen 702, 703 laid over the LCD panel, which may require use of a hard stylus. This is an intuitive control. A small number of control buttons 706 are usually included and for example one may be made a “Return to Start of GUI” button. The Sharp SL-5500 “Zaurus” includes a distinct button keyboard while a keyboard is an optional plug-in extra for the Palm.
(c) internal processing means: All types provide for third party applications using high-level software such as Java, “C”, SQL, HTML, Linux, TCP/IP or the like.
(d) wire-free communications: A bidirectional infra-red link is the norm for PDAs, though “Bluetooth” wireless or the like links by means of expansion cards is also commonly used.
(e) a graphical user interface: A GUI according to the invention (art only shown in FIG. 7 as branch 404 bearing several icons eg the CHEMIST icon, here highlighted because, being central on the screen, itis assumed to be the desired icon) can be held in Flash RAM storage. In FIG. 7 we show (by way of example) a split screen. The top part 702 shows the currently active icon within apart of the GUI and the bottom part 703 shows some illustrative options 704 brought up for the active icon.

Sensitive patches 705 for touching/tapping in order to steer the GUI may be generated in software and made visible on the screen. Only two are shown in this illustration as hatched rectangles, though other numbers such as four, eight, or nine (cf FIG. 8) may be used. This group in general lacks means to be a telephone, although the Dell “Axin” includes a microphone and speaker. The packaging and intended use of these devices is fully compatible with the intended mode of use though we added a loop for a neck cord at 700. The Sony NZ90 CLIE includes a 2M pixel digital camera, the PALM™ operating system, a 320×480 colour display, and Bluetooth. That digital camera may be suitable for webcam type phone conversations, to talk to relatives and for tele-medicine consultations. FIG. 6 is a block diagram of a PDA 600 having a display 601, a pointing/control input device 602, with a joystick 602A, a processor 603, and a network interface device 604 for lining the device to a network 107. A speaker 605 may be used to support interaction. A battery pack is not shown. Batteries may be charged in a cradle or by means of inductive coupling.

GUI host is a smart cellular telephone (Motorola (A760), Nokia, Philips, Qtek, Sony/Ericsson (P800), and other manufacturers) These can be regarded as limited PDAs (see above) with added cellular telephone functions.
(a) display means: a large legible LCD panel that comprises a fully program-controlled monochrome or colour pixel array, with back-lighting
(b) user-controllable inputs: a touch-sensitive screen forming part of the LCD panel. It may require use of a hard stylus. This is an intuitive control.
(c) internal processing means: can accept third-party application programmes.
(d) wire-free communications: wireless and infra-red bidirectional ports.
(e) a graphical user interface: may usefully be loaded as a Linux-compatible application.

The Motorola A760 is Linux-based and includes a digital camera, speakerphone, and a joystick. A virtue of using a device of this type as the person's first and possibly only control device is that it provides a telephone as well, so that the widest range of important communications/entertainment channels can be controlled from a single device. It is often cheaper for a person to have a cellular telephone account than to rent a landline, particularly if internet access is provided through a service other than a cellular service. Text messaging is currently a popular version of cellular telephone communications.

GUI host is an optimised device based on the invention. This allows best matching of desired functions with those provided, and should lead to cost savings. See FIG. 8.
(a) display means 803: a pixel-based addressable liquid crystal display (LCD) as large as convenient, preferably clear for viewing and in colour. (In FIG. 8 the display is showing 402 a branch of the GUI of FIG. 4) with the CD player icon highlighted).
(b) user-controllable inputs including an effective touch-screen input (with GUI steering patches such as 804), also an optional joystick 802 or other hand-controlled pointer, micro-phone 807, speaker 806, and other options, such as a plug-in keyboard.
(c) internal processing means: capable of supporting the basal functions and of accepting third-party software into storage for running as required
(d) wire-free communications: This device may use a conventional cellular network via aerial 801 for telephone functions, and a local network optionally also using antenna 801 according to standards such as “Bluetooth” or other accepted network protocols, for in-house functions.

In comparison to the A760, a device 800 designed from the ground up may have as large a touch-sensitive screen 803 as possible. The telephone buttons 805 may be presented as touchable areas upon the large screen, using large, legible formats. Note that at this time, cellular telephones are getting smaller, and most products suffer from “over-design”. No manufacturer of cellular telephones appears to have designed a version adapted for older people even though they are a growing part of the world's population. There is a need for a “big-button” version adapted for people with poor eyesight The larger case size would help an elderly person to hold and to find their cellphone, and in particular to locate the speaker aperture (which could be made louder) during use. There may be an inductive output to suit some hearing aids. A larger case can hold a larger battery. Less miniaturisation of components allows a reduction in cost.

Touch screens in their commonly sold form may not be suitable for elderly people with dry fingers or a light or erratic touch. Of the several types available (including 4-wire and 5-wire resistive, or capacitative types) those adapted for use by gloved fingers may be preferable. See for example the 3M “Microtouch Cleartek” range; or the Near Field Imaging™ range for examples of capacitative touch screens. A stylus can be used, preferably tied to the unit. A joystick option (or a connector for use with a range of control devices for people with various disabilities) should be developed in parallel.

GUI Host is the STB Itself (or Equivalent), as Shown in FIGS. 1 and 2.

(a) display means: the television set or similar which also serves to display STB output and will often be the subject of the person's attention,
(b) user controllable input device: may be tailored to the user's specific requirements and changed from time to time as the user's capabilities change, such as a mouse, or analogous pointing device (trackball, digitising pad, or the like), a touch screen (touch an edge to move that way, or touch the visible icon to work with it), a joystick probably employing switch contacts for sensing side movement and downwards pressure), specialised control devices such as an interface glove, a bulb switch, or a pressure switch in a seat, perhaps speech, hand gestures, eye movements—as is known in the disabled interfaces arts, or a standard keyboard.
(c) internal processing means: using the STB processor which usually has ample capacity and can run third-party programmes (see below),
(d) wire-free communications are not relevant in this case, unless the user-controllable input device itself is wireless (such as an infra-red mouse).

(e) a graphical user interface: held as software within the STB and displayed on the TV screen, most likely as an alternative to programme material. Of course the STB functions described in this document may be contained within the television set case, or emulated within a personal computer.

Set-Top Box (STB)

Device (b) is likely to be a STB, (also known as a “home gateway” or digital entertainment terminal) by which we mean a processor-driven digitally based site-programmable device that includes means to switch between a number of inputs, decode inputs if required, optionally store programmes, and deliver a selected program to a display appliance such as an ordinary TV set See Examples 1A and 1B below. The STB may be connected to one or more broad-band communications lines (cable, satellite, fibre-optics) carrying many entertainment, information, and data channels some of which are bidirectional. Preferably, though not essentially, the device can also handle-telephone communications either through the broad-band line or through a dedicated line. Continual evolution of personal computers and STBs may converge both devices into substantially the same device, in time. Preferably, though not essentially, the device can also handle commands to or messages from an intranet of local appliances such as heaters and security devices.

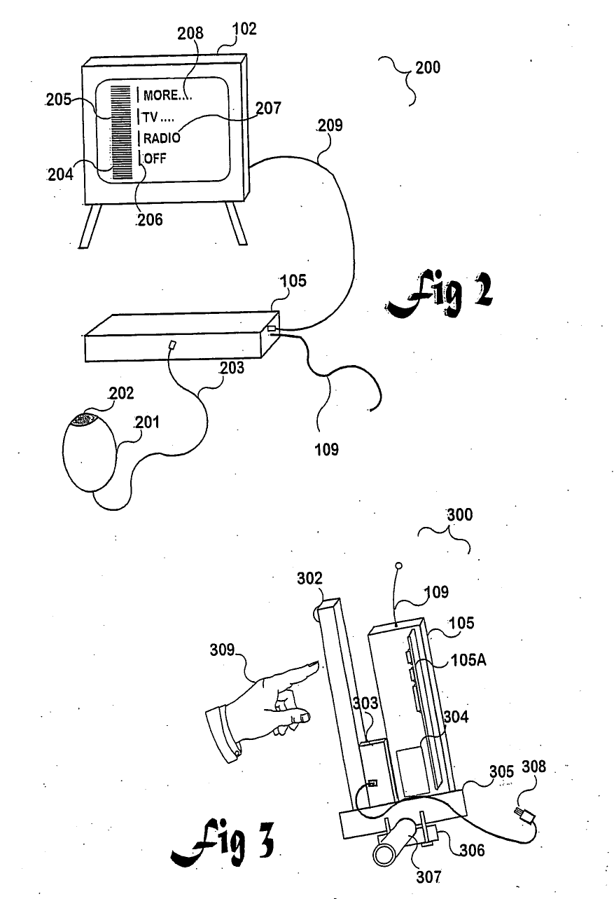

STBs comprise programmable electronic devices, made by many manufacturers, that receive signals from a variety of sources and convert a selection into a displayable form (eg a standard of video signals). For example, National Semiconductor Corporation provides the “Geode”© STB which is similar to a personal computer motherboard and which supports 80*86 family instructions hence can employ the operating systems Windows and Linux. Linux open-source software groups have formed a group known as “Linux4.TV” that prepares application software. The language used is dictated mainly by the hardware solutions selected. The “Geode” includes a plethora of inputs such as USB, IEEE 1284, infra-red, telephone, Ethernet, Smartcard, and video and audio, and also supports hard-disk storage of programmes for delayed replay. This system is designed to accept plug-in software modules. The STB may be contained within a single unit including the TV screen (FIG. 3), within the case of a standard television, or by emulated by a personal computer.

In-House Network

This (113, 114 in FIG. 1, the axis 403 in the GUI of FIG. 4, and Table 2) is an optional part of the invention, because it may be sufficient to connect a STB to a television set, to a source of programmes, and to a user's control device but have no other controlled devices or appliance. There are many standardised protocols for networks about a room or building, including dedicated wires, power-line wiring, infra-red (within a room) or various wireless networks. For the sake of illustration we shall assume that the widely known PC protocol as defined by Koninklijke Philips NV for a serial bus for a network is in use. The protocol has limits. It is a relatively short-range network and cannot carry video signals (although a USB-based bus may be able to). Many useful integrated circuits (chips) are produced for this protocol. At the STB, a software routine may be written and installed in order to drive the four-wire bidirectional network (data SDA, clock SCL, ground, and 5 volts) which uses master and slave addressable units so that many devices can share the cable. (The STB may already include an I²C. bus for internal commands). Any appliance to be controlled is given a specific address as part of an 8-bit word and a parallel digital input/output chip (PCF 8574) is hard-wired for that address. Then any 8-bit word accompanying that address word is mapped onto up to 8 control lines wired into the appliance so that a specific command such as on/off, more sound, play next CD, less light, or more heating can be invoked by the status (active or inactive) of each line. In the other direction, an event, measurement, or status that should be returned to the STB can be returned either from the appliance through the same type of chip to the STB which may be programmed to forward an indication to the person. Such information may include the current security status of doors and windows. Other chips can perform analogue-to-digital conversions and so return values from transducers for room lighting, heating or the like. Some sound systems and television receivers already use FC buses internally for command functions, so control from a STB via this bus may be imposed relatively easily.

For those appliances that can be controlled only though an infra-red link, there are specific chips and circuits to convert 0.12C data into infra-red, using designs that are well known in the art,

An appliance such as a television set is likely to be directly coupled to the STB so this network does not need to carry video signals.

### EXAMPLE 1B

As shown in FIG. 3 the entire invention could be constructed in a physical form like that of a laptop computer (with a backlit colour 14 inch LCD display screen 302 presented to the user, and control means 105, power supply 303 and communication means 310 behind). A conventional computer (perhaps on the floor or on a wall) with an LCD screen supported in front of the user may be a useful alternative. A TV card including a chip such as the Philips SAA7134HL can accept television images from a tuner as composite video signals from satellite, cable, or terrestrial origins, or from a local camcorder and convert that (or control information) into a digital signal for display through the computer's graphical output device (LCD or CRT). At the same time sound can be handled and passed to a sound card. A physical arrangement 300 may be clamped by clamp 306 onto a pipe 307 forming part of a bed, table, a wall-mounted or a free-standing support. This drawing does not include a preferred protective case surrounding the interior modules. The display screen can include a touch screen (cf patient hand 309) for controlling the interface. This Example physically combines the STB (105, with internal component board 105A) and the entertainment display module. By way of example, a “Geode” STB mother board 105A includes two standard PCI bus sockets. A computer graphics card 304 inserted in one of them can drive the LCD screen 302 with television images, control text, Internet browser screens, and the like. (This approach overcomes the relatively poor resolution and high power consumption of a standard television set). There is already an ample range of application software for e-mail or fax usage.

Range of Personal Abilities.

One end of the range is normal, computer-familiar persons who would use the GUI with interfaces (such as personal computers, TV remote controls, and the like). Mid-range people are older, (perhaps those finding it rather difficult to continue living at home) and would in the main use the same equipment. People at the high-disability end of the range would require a range of usually novel interfaces specifically adapted for low-frustration use and matched to the needs of the person. Loss of memory syndromes and dementias are common sequels of old age and it is desirable to compensate for these disabilities as far as possible. The effectiveness of any particular control interface from within the range is broadly similar to that of any other—or at least to related controls within the entire range. Possibly the simple-to-use interfaces will not have as much capability as a versatile yet more complex interface. It has always been a challenge to raise functionality yet retain simplicity.

It is difficult to be specific about details of the range of specific interfaces themselves because they can be very user-dependent Design is quite open-ended and amenable to a good deal of psychological planning as well as fundamental common sense. Within a specific physical interface, different instruction sets may be written in order to provide further levels of matching of facilities to any one individual user's faculties. As is well known in the art, a variety of modes may be included within one programme and selected on the spot by reading of (for example) a DIP switch mounted on a circuit board of the interface or a virtual equivalent such as a bit in flash memory. A caregiver or specialist can then match the interface to the person's needs without having to supply a large variety of physical items.

Any individual may progress from level 1 down the following list should their faculties become impaired (and may revert to a higher level if recovered). Illustrative conditions are:

Level 1

The user has all faculties although he or she may be unable to move around. Keypads (as used in ordinary remote controls, telephones, cellular telephones), full keyboards, as in personal computer type controls, and PDA control perhaps with a stylus are applicable. Messages can be created for sending by speech, optionally with a “webcam”, by typing, or by writing with the scriber.

Level 2

Weakened eyesight (strong glasses, cataracts, retinal degeneration, etc) A remote control in which colour is used to identify the parts. (For example large indicia and bright bands of colour). Coloured LEDs on the remote control may flash to acknowledge commands. Any screen messages involved in control are in large fonts and preferably white letters on black or dark blue because of light scattering by a cloudy lens. Messages can be created for sending by speech, optionally with a “webcam”, by typing, or by writing with the scriber.

Level 3

Substantially no eyesight. A remote control in which Braille or similar is used to identify the parts. A video output from the STB CTV etc) may not be necessary. A text-to-speech device such as a “BaBel Infovok”™ converter, to help give the person feedback when controlling the invention, and for many uses such as converting e-mails, e-Books, and Web pages to speech would help to overcome the disability. Messages can be created for sending by speech, optionally with a “webcam”, and possibly by typing, or by writing with the scriber.

Level 4

Needs sound or speech for the entry of commands, such as for people whose arthritis prevents them from holding remote controls and pressing buttons. There are a number of voice recognition systems. Another alternative involves use of a touch surface as a pointing device. Yet further alternatives may make use of a track ball, a cord that can be pulled, tilting of the head, or the like. Messages can most easily be created for sending by speech, optionally with a “webcam”. The spoken word may be transmitted as such or converted into text as for an e-mail.

Level 5

Little or substantially no hearing. Keypads (as for ordinary remote controls). Personal computer type controls. Palm computer control. Audible outputs of the set top box not required, most probably. The set top box may include a “dictation reader” software package so that words spoken are displayed as text, and may also include or cater for facilities that either provide or emulate the various telephone-based systems (such as TTY) that allow hearing-impaired people to send messages by telephone. (Any specific interface should also be able to receive the increasingly popular text messages and display them). Messages can be created for sending by speech, possibly, optionally supplemented with a “webcam”, by typing, or by writing with the stylus.

Level 6

Stroke, head injury, multiple sclerosis, motor neurone disease, or similar motor disabilities. One principle of this invention is to give people the opportunity of becoming accustomed to the GUI in itself and as a way of controlling appliances, A-V channels and communications prior to really needing it. One possibility is the use of speech as the controlling event. Others are finger pressure, eyelids, jaw movement, etc., and possibly squeezing a rubber bulb to cause a manometer display to rise and fall on a screen. This option 200 is shown in FIG. 2. The rubber bulb 201 also includes a nurse call button 202 and a pressure transducer within is connected by wire 203 (or infra-red link) to the STB 105. The television-type display 102 is shown with a “manometer metaphor”204—currently reflecting squeeze pressure by rising to 205. This interface may be configured so that after a short period of squeezing the bulb at a more or less constant pressure, the choice such as 207 at the right of the guide line 206 is activated, and optionally acknowledged in an “are you sure?” mode. Where a choice leads to further choices, the row of dots 208 favoured for indicating further choices in computer menus may be used. No squeeze at all deactivates the menu screen and the system reverts to showing television, for example. The reader will appreciate that software gives a designer a considerable amount of freedom to create a complete interface using nothing more complex than a squeezable bulb.

More elaborate control means for severely disabled persons may involve a video camera scanning the individual's face, connected to image processing hardware capable of interpreting facial expressions or eye directions for example as controlling events. Messages can be created for sending with relatively more difficulty in this group by speech, optionally with a “webcam”, by typing, or by writing with the stylus. They may be decoded into text characters. The sender may be pleased to have a caregiver edit the messages before they are transmitted.

Level 7

Mental faculties impaired—eg Alzheimer's disease, dementia, head injury, etc. Very simple interfaces such as only “yes/no” choices (never multiple choices), uncomplicated questions, the machine may remember previous successful connections (and may rate more highly those connections that were used for longer periods), and a care-giver may programme the invention to provide a set of entertainment events over a period, using EPG (electronic program guides) if available. How messages may be sent depends on the extent of the person's disability.

Information Content

The invention also covers at least some of the information presented to the user. For example, a web page provider may generate a number of web pages for which the presentation, degree of difficulty, and informational relevance is attuned to the kind of specific interface in use perhaps by including a specific identifier within the metatags attached to each page. For example a blind person's use of the Internet would be totally different to that of a deaf person, and an elderly person using a simplified presentation interface may prefer to hear songs from their youth rather than songs that appeal to modern teenagers.

A useful form of web page is one connected to a health care services provider, such as the medical practice that the individual uses. The citation on “Workshop on Home Care Technologies for the 21st Century” is especially relevant to this aspect Two-way communications would be useful, especially if supplemented by devices such as a digital or “web-cam” camera. Related pages may be connected to pharmacy (chemist—FIG. 7), ambulance, etc. Another web page may be connected to pastoral care from a minister of religion, his/her church, or the like. Yet another useful web page is directed to ensuring that an elderly person living alone is eating properly. This page may employ interesting menus or comprise pointed reminders.

Another useful form of web page is that made up by a relative's family. Access to this web page may be restricted to other members of the family so that more personal material can be loaded. Informal and easily updatable web pages are currently known as “blogs” and fill a gap between formal, fixed, and carefully designed web pages and text in chatrooms. Passwords may be loaded in to the individual's own set top box so that they need not be upgraded in the specific interface is exchanged. Movies and sound clips can be included. Using the webcam, two-way videophone calls can be arranged with any other Internet user. (Many elderly people lack visitors because often families move to other cities or other countries. The cost of transport is more likely to rise than to fall in the future).

### Variations

If a large number of original sources of entertainment, arriving through a number of separate input cables exist, one solution is to externally combine the original channels of communication into a single broadband signal (such as a local broad-band radio link picked up by aerial 310 or an optical signal carried in an optical fibre), so that at most one conducting lead (plus mains power, 308) goes to the invention. This variation may interest an advanced cable television provider. Such a business may gain income in return for services by providing advertising appropriate to the market being catered to.

Home health monitoring on a community-wide scale may be based on this invention plus management schemes and a variety of data collection devices such as heart rate loggers, blood pressure-recorders, web cameras and the like.

Particularly for the more extreme cases of disability, another person can load the set top box with a sequence of instructions comprising a programme of entertainment, selected with the help of a schedule of daily programmes from any of the sources available at the particular set top box. This may be done by any person and it may be done by downloading the sequence from another site. Electronic programme guides EPGs) are a form of this activity. We assume that the STB includes a clock and timer. Often a problem is that there is nobody available to turn the tape over, or to switch the television on when a selected programme is starting.

An equivalent of a “toll bar” may be needed in some cases to control access to those services which charge for use Some service providers assume that all their customers have a large, continuous income.

### Commercial Benefits or Advantages

1. The invention allows individuals to interact with the world throughout their lives, even with advancing decrepitude caused by age, accident, or ill heath. In particular it allows individuals to get familiar with the interface well before any possible disability, so enhancing their chances of returning to communication, entertainment, and the lie.

2. The invention permits individuals to stay at home, managing their affairs, doing shopping, being able to call for medical aid, and communicating with friends and relatives, for longer than might otherwise be possible. This is fully consistent with world-wide Government policies for minimising time spent in institutional care.

3. The invention makes a period of reduced mobility more stimulating and should result in healthier, happier people. For example it improves the possibility of bidirectional communication with remote friends and relatives. Kids don't often write letters but they would send Granny a text message.

4. One problem with being cared for in a home is that there is rarely enough “minder time” to change over an immobilised patient's radio, TV, or tapes as soon as the current event is finished. With this invention, a care-giver may programme the set top box through its interface (or through another interface) to provide a set of entertainment events over a period, based for example of a list of radio and/or television programmes GAPG). This could be done over a remote link,

Finally, it will be understood that the scope of this invention as described and/or illustrated herein is not limited to the specified embodiments. Those of skill will appreciate that various modifications, additions, known equivalents, and substitutions are possible without departing from the scope and spirit of the invention as set forth in the following claims especially given the wide variety of disabilities that are likely to occur.

1. An adaptable world interface including a graphical user interface (GUI), support hardware, and software for maintaining personal access to services, information and entertainment from audio-visual channels, communications channels, and the like over a long period, even if the individual becomes disabled characterised in that the means includes an adaptable GUI menu capable of displaying (a) a variety of presented levels of complexity, any one level of which may be selected from time to time according to the individual's level and (b) a consistent spatial layout regardless of the currently presented level of complexity, a selected GUI host device capable of presenting the menu to the user, at least one adaptable means for accepting at least one actuating command from the user, at least one operable device capable of being controlled by the GUI host device in response to an actuating command, and an output device capable of displaying the audio-visual channels, communications channels, and the like so that an individual of any level of capability is able to comprehend a compatible GUI menu and operate the system control interface, the adaptability giving the individual an opportunity of becoming accustomed to the invention over a period prior to a possible onset of disability.

2. An adaptable world interface as claimed in claim 1, characterised in that the at least one operable device comprises a set-top box (STB); the STB being capable of selecting at least one channel of information and entertainment for personal access by the individual.

3. An adaptable world interface as claimed in claim 1, characterised in that the operable device is provided with means for communicating with at least one appliance connected to the operable device.

4. An adaptable world interface as claimed in claim 1, characterised in that the individual's responses are received by ability-scalable means capable of being altered according to the level of capability of the individual, so that an individual of any level of ability is able to control the system.

5. A GUI menu for an adaptable world interface as claimed in claim 1, characterised in that the menu is presented to the individual in visual form by an output hardware device, the menu is designed so that a view of a portion of the menu includes information locating that view within the whole, the menu is laid out in a spatially consistent manner in which a plurality of items are displayed in consistent positions (if present), regardless of level of complexity, and the menu is viewed through a virtual window, the size of which may be altered according to the level of capability of the individual, so that an individual of lower level is not confused yet an individual of higher level is not frustrated.

6. A GUI menu for an adaptable world interface as claimed in 5 characterised in that the menu has an appearance comprising a number of curved limbs, each festooned with at least zero icons, each representing an item.

7. A GUI menu for an adaptable world interface as claimed in 5 characterised in that the menu is presented to the individual in audible form, and the one or more actuating commands are created by the individual in audible form.

8. An adaptable world interface according to claim 1 for linking one or more persons with a health services provider, characterised in that the means includes a GUI, together with hardware for personal health status data collection, in order to facilitate health consultations remotely, so that community health services may be made more proactive.

9. An adaptable world interface according to claim 1 for supplying one or more persons with audiovisual material, characterised in that at least some of the material is collated by electronic programme, gathering means so that the individual can enjoy the material without having to pursue the material on a programme-by-programme basis.

10. Means for linking one or more persons with an audiovisual channel provider, characterised in that at least one channel of audiovisual material is brought to the operable device as claimed in claim 1, and the at least one channel carries material relevant to the persons in the dwelling, so that the persons are supplied with relevant audiovisual material.

11. A method for providing a person having a level of disability and/or a level of competence with an adaptable world interface characterised in that the method includes the steps of (a) assessing the person's current level of disability and current level of competence, (b) selecting an appropriate GUI and GUI host in combination, (c) configuring the GUI to match the assessed level of current level of disability and current level of competence, (d) selecting an appropriate user control device, and (d) verifying from time to time that the person's current level of disability and current level of competence is still matched by the configuration of the GUI and GUI host, so that the person can operate the adaptable world interface with some confidence.
